(19) United States
(12) Patent Application Publication
(10) Pub. No.: US 2014/0183801 A1
(43) Pub. Date: Jul. 3, 2014

(54) HYDRO ROLL ROD

(71) Applicants: Hyundai Motor Company, Soul (KR); Pyung Hwa Industrial Co., Ltd., Daegu (KR); Kia Motors Corporation, Seoul (KR)

(72) Inventors: Hee-Sung Lee, Suwon (KR); Jong-Su Park, Daegu (KR); Pan-Kyu Choi, Daegu (KR)

(73) Assignees: HYUNDAI MOTOR COMPANY, Seoul (KR); PYUNG HWA INDUSTRIAL CO., LTD., Daegu (KR); KIA MOTORS CORPORATION, Seoul (KR)

(21) Appl. No.: 13/954,208

(22) Filed: Jul. 30, 2013

(30) Foreign Application Priority Data
Dec. 31, 2012 (KR) 10-2012-0158674

(51) Int. Cl. F16F 13/08

(52) U.S. Cl. CPC F16F 13/08
USPC 267/140.11

(57) ABSTRACT

A hydro roll rod that includes a first liquid chamber and a second liquid chamber formed in a rear insulator and configured to provide a space in which a fluid is stored. A rod case is extended toward an outside from a portion where the first liquid chamber and the second liquid chamber are partitioned and configured to support a load. A first bridge encloses an outer circumference of the second liquid chamber and coupled to one side surface of the rod case. A second bridge encloses an outer circumference of the first liquid chamber and coupled to one side surface of the rod case. A plate is fixedly coupled to an end of the second liquid chamber. A first bracket encloses and supports outer circumferences of the first bridge and the plate, and a second bracket encloses and supports an outer circumference of the second bridge.

### CROSS-REFERENCE TO RELATED APPLICATIONS

The present application claims priority of Korean Patent Application Number 10-2012-0158674 filed Dec. 31, 2012, the entire contents of which application is incorporated herein for all purposes by this reference.

### BACKGROUND OF THE INVENTION

1. Field of the Invention

The present invention relates to a hydro roll rod, and more particularly, to a hydro roll rod capable of simplifying a structure of a liquid chamber and reducing the likelihood of oil leak by forming an integrated vulcanized rubber when configuring the hydro roll rod which fills a roll rod with a liquid.

2. Description of the Related Art

In general, as a way of supporting a power train of a vehicle, an inertia support, a central support, and a complex support are used. At present, among them, the inertia support, which has a comparatively excellent idle performance, is widely used, and the inertia support refers to a support using a principal axis of inertia of an engine and is classified into a four point support and three point support according to the number of mounts used.

The four point support refers to a type of support in which an engine mount and a transmission mount are positioned at an upper end or a lateral surface of a side member of a vehicle body, and front and rear roll mounts are mounted at a sub frame. In contrast, the three point support type adopts a support in which an engine mount, which is configured on one side of an engine, and a transmission mount, which is configured at one side of a transmission, are mounted at the upper end or the lateral surface of the side member of the vehicle body, identically to the four point support, and a roll rod instead of the front and rear roll mounts is mounted at a sub frame accordingly.

In recent years, the inertia three point support has been applied to and adopted for most of high torque engines of medium/large sized vehicles. Further, as an I-shaped sub frame is widely adopted in order to decrease a weight of the vehicle, importance with respect to the three point support is being emphasized. Therefore, development on an appropriate roll rod is necessary, and as a result, a type of support is used in which one side of the roll rod, which is used in the three point support, is fixed to the power train, and the other side is fixed to the sub frame.

Meanwhile, in the aforementioned roll rod, typically, a rear insulator more sensitively responds in order to insulate impact and vibration than a front insulator connected to the power train, and therefore the relevant industry makes a great effort to improve performance of the roll rod by developing the rear insulator.

Accordingly, a dog bone type roll rod is widely used in the related art, and the dog bone type roll rod includes a rod, a front insulator, and a rear insulator. The two rear insulators are positioned between the rod and an end plate so as to face each other, the end plate and the rear insulator are fixed to the rod by a penetrating bolt that penetrates centers of the end plate and the rear insulator, and the roll rod is fixed to the sub frame of the vehicle body by connecting a body bracket between the respective rear insulators.

The dog bone type roll rod is very durable because two rear insulators receive compressive loads in front and rear directions, respectively, when the power train, which is connected to the front insulator, is operated in the front and rear directions.

However, because the aforementioned dog bone type roll rod in the related art is weak during impact and vibrations that are produced particularly when the vehicle is turned on or turned off, or when the vehicle rapidly accelerates and stops, the insulation performance with respect to vibration and noise, which are transmitted toward the vehicle body, overall deteriorates, and therefore there is a problem in that noise, vibration and harness (NVH) performance of the vehicle deteriorates.

In order to solve the problem, a hydro roll rod illustrated in FIGS. 1 and 2 has also been used. hydro roll rod has a structure in which an inside of the insulator is divided into a large liquid chamber 1 and a small liquid chamber 2 by a membrane 3, and a fluid filled in the large liquid chamber 1 and the small liquid chamber 2 moves through an orifice 5. Further, a rod case 6 and a bridge 7 are formed at an outer side of the large liquid chamber 1 so as to transmit the vibration and maintain an outward appearance, and a stopper 8 is formed below the rod case 6 and the bridge 7.

However, because a number of separate components such as the membrane, the orifice or the like are needed to implement the hydro roll rod, and the hydro roll rod has a structure in which each of the separate components are coupled to and assembled with each other, there is problems with sufficiently sealing the structure when the fluid moves, and thereby oil leaks and performance deterioration are common in hydro roll rods.

In addition, while there is the stopper 8 that controls flow in forward and backward directions when monitoring durability of a single article and the vehicle, the stopper 8 can only stop the fluid flow in one direction (i.e., the right direction), as illustrated in FIG. 2, but the stopper 8 cannot serve as a left directional stopper, and as a result, durability is weakened. Further, the configuration in which the stopper 8 stops the movement of the rod case 6 and the bridge 7 in order to prevent high stress from being applied when the flow is made in the front and rear directions is weakened in durability, thereby not being applicable to mass production.

In addition, because only the bridge 7 is made of a rubber material, only one rubber material may be tuned when there is a deficiency in the rubber material, and characteristics in the front and rear directions may not be differentiated as a result.

### SUMMARY

The present invention has been made in an effort to provide a hydro roll rod capable of achieving a structure of the hydro roll rod without using individual components which create a complicated structure like in the related art, and prevents leakage of the fluid and at the same time improves durability and reduces vibration by manufacturing structures made of rubber material as a vulcanization integral structure.

An exemplary embodiment of the present invention provides a hydro roll rod including: a first liquid chamber and a second liquid chamber smaller than the first liquid chamber formed in a rear insulator, and configured to provide a space in which a fluid is stored; a rod case extended toward the outside from a portion where the first liquid chamber and the second liquid chamber are partitioned and configured to support a load; a first bridge configured to enclose an outer circumference of the small liquid chamber and coupled to one side surface of the rod case; a second bridge configured to enclose an outer circumference of the first liquid chamber and coupled to one side surface of the rod case; a plate fixedly coupled to an end of the second liquid chamber; a first bracket configured to enclose and support outer circumferences of the first bridge and the plate; and a second bracket configured to enclose and support an outer circumference of the second bridge.

In addition, a nozzle may be formed at a portion where the first liquid chamber and the second liquid chamber are partitioned to be extended from an end of the first bridge to the inside of the hydro roll in order to adjust a flow of the fluid.

In addition, the nozzle may be formed to be integrally extended from an end of the first bridge, and may be spaced apart at a predetermined distance from an outer side surface of a bolt having a center at which an end of the nozzle is positioned. As the first liquid chamber or the second liquid chamber is compressed, the nozzle may be curved in left and right directions to form a flow path through which the fluid included in the first liquid chamber and the second liquid chamber is able to move. Moreover, the first bridge, the rod case, the plate, and the first bracket may be formed integrally rubber vulcanization.

According to the exemplary embodiment of the present invention having the aforementioned configuration, in order to improve a leakage within the hydro roll rod used in the related art, the rod case, the bridge, the plate, and the like are integrally formed via the rubber vulcanization, and therefore a structure of each component may be simplified, oil leak may be prevented by simplifying the existing portions that have a weak, and assembly defects may be minimized by simplifying assembly structures.

In addition, when flow force is applied in the forward direction, the first bridge and the first bracket, which are flow members, are stopped by the rod case so that low stress is applied to the first bridge, and when a flow force is applied in a backward direction, the second bridge and the second bracket, which are flow members, are stopped by the rod case so that a lower amount of stress is applied to the second bridge, and as a result, s forward and backwards directions may be supported and durability may be improved.

In addition, because rubber materials are applied to both the first bridge and the second bridge, various vibration performances necessary for the roll rod may be set, and characteristics in the forward and backward directions may be differentiated for each bridge and may be variously set.

### BRIEF DESCRIPTION OF THE DRAWINGS

FIGS. 1 and 2 are schematic views illustrating a hydro roll rod used in the related art.

FIG. 3 is a perspective view illustrating a hydro roll rod according to an exemplary embodiment of the present invention.

FIG. 4 is a cross-sectional view illustrating a hydro roll rod according to an exemplary embodiment of the present invention.

FIG. 5 is an enlarged view illustrating a liquid chamber and a nozzle part of the hydro roll rod according to the exemplary embodiment of the present invention.

FIG. 6 is a view illustrating a process in which a fluid moves when a second liquid chamber is compressed in the hydro roll rod according to the exemplary embodiment of the present invention.

FIG. 7 is a view illustrating a process in which a fluid moves when a first liquid chamber is compressed in the hydro roll rod according to the exemplary embodiment of the present invention.

FIG. 8 is a graph illustrating a vibration reduction value and a Kd value of the hydro roll rod used in the related art.

FIG. 9 is a graph illustrating a vibration reduction value and a Kd value of the hydro roll rod according to the exemplary embodiment of the present invention.

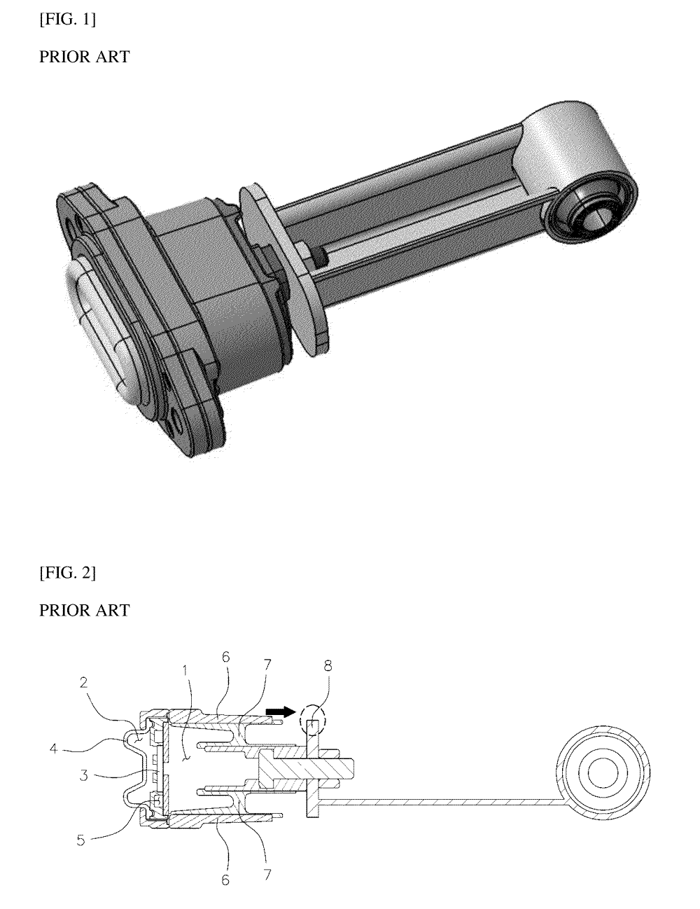

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the present invention will be described in more detail with reference to the accompanying drawings.

A hydro roll rod of the present invention may include a first liquid chamber 10 and a second liquid chamber 20 which is smaller than the first liquid chamber which are formed in a rear insulator to provide a space in which a fluid is able to be stored, a rod case 50 which is extended toward the outside from a portion where the first liquid chamber 10 and the second liquid chamber 20 are partitioned, and supports a load, a first bridge 30 which encloses an outer circumference of the second liquid chamber 20, and is coupled to one side surface of the rod case 50, a second bridge 40 which encloses an outer circumference of the first liquid chamber 10, and is coupled to one side surface of the rod case 50, a plate 60 which is fixedly coupled to an end of the second liquid chamber 20, a first bracket 80 which encloses and supports outer circumferences of the first bridge 30 and the plate 60, and a second bracket 90 which encloses and supports an outer circumference of the second bridge 40.

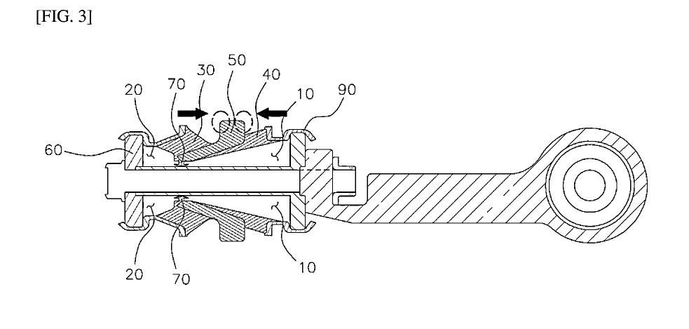

As illustrated in FIG. 3, a general shape of the present invention has a form similar to a form of a roll rod or a hydro roll rod, which is used in the related art, in consideration of a characteristic that the present invention is used in an engine and a power train, but an internal structure and specific characteristics of the roll rod are very different from those of the roll rod or the hydro roll rod that is used in the related art.

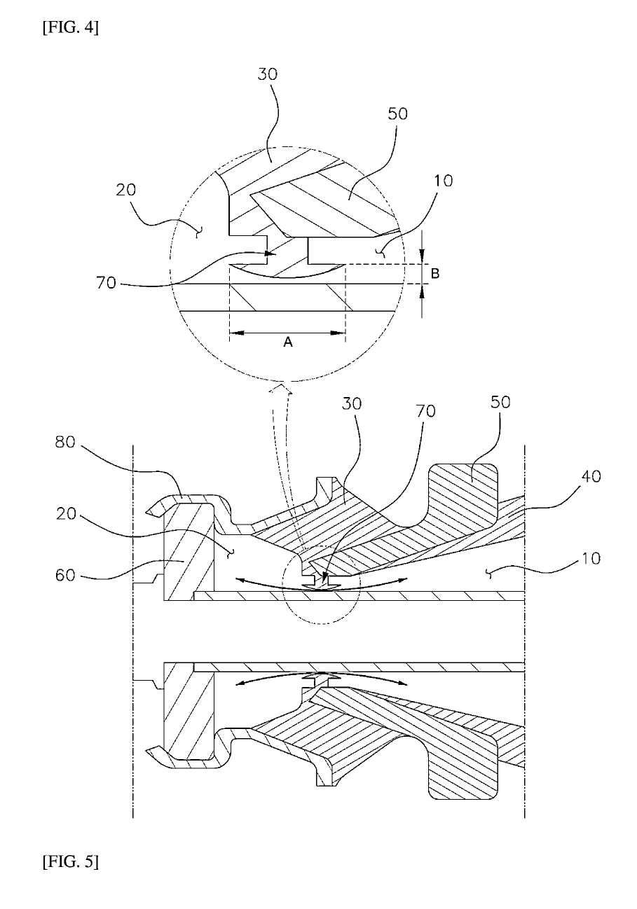

Namely, as illustrated in FIG. 4, the present invention relates to a hydro roll rod in which a fluid is stored in the rear insulator of the roll rod, and vibration reduction performance is achieved according to the movement of the fluid. Particularly, a space is formed in which the fluid is able to be stored by enclosing a circumference of a bolt at a center portion along a longitudinal direction of the hydro roll rod, the first liquid chamber 10 and the second liquid chamber 20 are positioned in turn, and the first liquid chamber 10 and the second liquid chamber 20 are positioned closely with a passage through which the fluid is able to move therebetween.

Meanwhile, the first liquid chamber 10 is formed to comparatively have a longer length and a larger volume than the second liquid chamber 20. In the present exemplary embodiment, the first liquid chamber 10 is formed to have a length about two times longer than a length of the second liquid chamber 20.

The rod case 50 is formed toward an outside of the roll rod from a portion where the first liquid chamber 10 and the second liquid chamber 20 are partitioned, and the rod case 50, as illustrated in FIGS. 3 and 4, is formed to broadly protrude along a circumference of a center portion of the rear insulator.

Therefore, considering that a portion where the first liquid chamber 10 and the second liquid chamber 20 are partitioned is positioned at a position about ⅓ of the rear insulator, and a protruding portion of the rod case 50 is positioned at a position about ½ of the rear insulator, the rod case 50 is curved in a predetermined form to protrude toward the outside while being curved in an ‘ [symbol] ’ shape, supports a load applied to the rear insulator, and thus may easily reduce a flow in front and rear directions.

That is, when a flow is made in the front direction, the first bridge 30 and the first bracket 80, which are flow members, are stopped by the rod case 50 so that low stress is applied to the first bridge 30, and when flow force is applied in the rear direction, the second bridge 40 and the second bracket 90, which are flow members, are stopped by the rod case 50 so that low stress is applied to the second bridge 40, and as a result, stresses both the forward and backward directions may be supported and durability may be improved.

In addition, the first bridge 30 encloses the outer circumference of the second liquid chamber 20, the plate 60 having a flat plate shape is fixed to the end of the second liquid chamber 20, and the first bracket 80 having a curved shape, that is, a ‘ [symbol] ’ shape, is coupled to outer circumferences of the first bridge 30 and the plate 60.

That is, the first bracket 80 encloses the outsides of the first bridge 30 and the plate 60 to serve to maintain the form of the hydro roll rod and protect the first bridge 30 and the plate 60 from exterior impact, corrosion, and the like. Particularly, the first bracket 80 forms the outer circumference of the second liquid chamber 20 together with the first bridge 30 and the plate 60, and therefore the space is formed in which the fluid filled inside is stored.

Of course, the first bracket 80 may be manufactured to have various sizes and shapes in accordance with sizes and shapes of the first bridge 30 and the second liquid chamber 20, and a required vibration reduction value. Similarly, the second bridge 40 is formed at the outer circumference of the first liquid chamber 10, and the second bracket 90 is formed at the outer circumference of the second bridge 40 similarly to the first bracket 80, and thereby the space is provided which supports the second bridge 40 and forms the first liquid chamber 10.

In addition, a nozzle 70 is formed at a portion where the first liquid chamber 10 and the second liquid chamber 20 are partitioned to be extended from an end of the first bridge 30 toward the inside in order to adjust the flow of the fluid, and more detailed configurations of the nozzle 70 are illustrated in FIGS. 5 to 7.

Referring to FIG. 5, the nozzle 70 is formed on a boundary line of a fluid passage where the first liquid chamber 10 and the second liquid chamber 20 meet, and the fluid included in the first liquid chamber 10 and the second liquid chamber 20 moves in accordance with movement of the nozzle 70.

In addition, the nozzle 70 is formed to be integrally extended from the end of the first bridge 30, and may be spaced apart at a predetermined distance from an outer side surface of the bolt having a center at which an end of the nozzle 70 is positioned. That is, as illustrated in an enlarged view of FIG. 5, the nozzle 70 is formed with an extension portion directly connected to the first bridge 30, and an open-close portion roundly and broadly formed at an end of the extension portion to have a semicircular shape. In accordance with an open-close operation of the nozzle 70, a flow path (orifice) of the fluid, which moves to the first liquid chamber 10 and the second liquid chamber 20, is formed.

In addition, there is an advantage in that a length (A of FIG. 5) of the nozzle 70 and a sectional area (B of FIG. 5) of the nozzle 70 may be freely adjusted to be formed in various shapes in accordance with a type of the vehicle or a required vibration reduction performance, and the flow path (orifice) of the fluid may be formed in various shapes in accordance with a shape and a size of the nozzle 70.

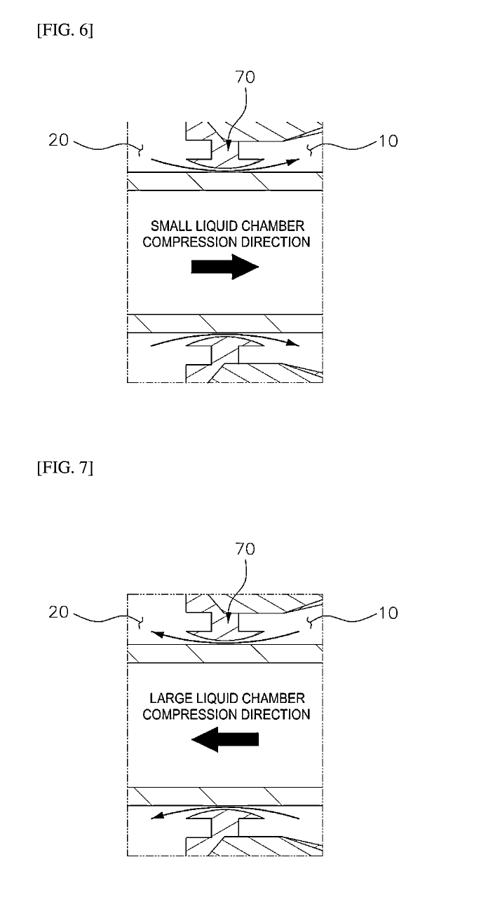

As the first liquid chamber 10 or the second liquid chamber 20 is compressed, the nozzle 70 is curved in left and right directions to form the flow path (orifice) through which the fluid included in the first liquid chamber 10 and second liquid chamber 20 is able to move. That is, as illustrated in FIG. 6, when the fluid in the second liquid chamber 20 moves to the first liquid chamber 10 as higher pressure is applied to the second liquid chamber 20, the nozzle 70 is curved while rotating toward the first liquid chamber 10 to form the flow path (orifice) of the fluid, and vibration is reduced as the fluid included in the second liquid chamber 20 moves to the first liquid chamber 10 along the flow path.

In contrast, as illustrated in FIG. 7, when the fluid in the first liquid chamber 10 moves to the second liquid chamber 20 as higher pressure is applied to the first liquid chamber 10, the nozzle 70 is curved while rotating toward the second liquid chamber 20 to form the flow path (orifice) of the fluid, and vibration is reduced as the fluid included in the first liquid chamber 10 moves to the second liquid chamber 20 along the flow path. Moreover, in the present invention, the first bridge 30, the rod case 50, the plate 60, and the first bracket 80 are formed in an integral type by rubber vulcanization.

In the hydro roll rod used in the related art, because a number of separate components such as membranes, orifices or the like are needed to implement the hydro roll rod, a the structure is weakened due to the number of joints and assemblies, and thereby oil leaks or performance deterioration is common

However, according to the present invention as described above, the rod case 50, the bridge, the plate 60, and the like are integrally formed by the rubber vulcanization, and therefore the effect may be achieved that a structure of each component is simplified, oil leakage is improved by simplifying the existing weak portions, and the assembly defect is minimized by simplifying assembly structures.

In addition, because rubber materials are applied to both the first bridge 30 and the second bridge 40, there are advantages in that various vibration performances necessary for the roll rod may be set, characteristics in the front and rear directions may be differentiated for each bridge, and a vibration reduction value of the hydro roll rod may be variously set as a tuning freedom increases.

The performances of the hydro roll rods of the present invention and the related art are tested and compared by using a graph.

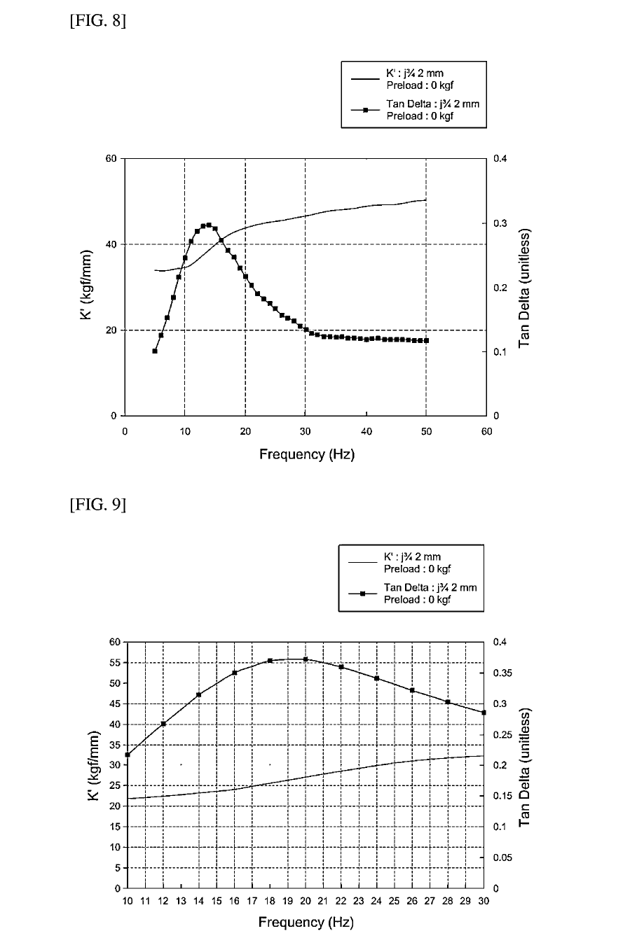

FIG. 8 is a graph illustrating the performance of the hydro roll rod used in the related art, and FIG. 9 is a graph illustrating the performance of the hydro roll rod according to an exemplary embodiment of the present invention. It may be known that in the hydro roll rod, as illustrated in FIG. 8, which is used in the related art, a maximum value of the vibration reduction value (Tan Delta) is about 0.29, and a Kd value, which represent the same characteristic, is about 44 Kgf/mm at 20 Hz, whereas in the hydro roll rod of the present invention as illustrated in FIG. 9, a maximum value of the vibration reduction value is about 0.37, and a Kd value is about 28 Kgf/mm at 20 Hz.

That is, considering that it is more advantageous in vibration performance when the reduction value becomes higher and the Kd value becomes lower, the hydro roll rod according to an exemplary embodiment of the present invention is improved by about 21.6% compared to the hydro roll rod used in the related art in terms of the reduction value. Particularly, C1 low frequency vibration is improved, and it may be known that as the present invention is improved by about 36.7% in terms of the Kd value, NVH performance is improved as well.

While the present invention has been described in terms of specific embodiments of the present invention, which are merely exemplary embodiments, and it should be appreciated that the present invention is not limited to those embodiments. The described embodiments may be changed or altered by the person skilled in the art without departing from the scope of the present invention, and various changes and alternations may be made within the equivalent range of the technical spirit of the present invention and the claims appended below.

What is claimed is:

1. A hydro roll rod, comprising:
a first liquid chamber and a second liquid chamber smaller than the first liquid chamber formed in a rear insulator and configured to provide a space in which a fluid is able to be stored;
a rod case extended toward an outside from a portion where the first liquid chamber and the second liquid chamber are partitioned and configured to support a load;
a first bridge configured to enclose an outer circumference of the second liquid chamber and coupled to one side surface of the rod case;
a second bridge configured to enclose an outer circumference of the first liquid chamber and coupled to one side surface of the rod case;
a plate fixedly coupled to an end of the second liquid chamber;
a first bracket configured to enclose and support outer circumferences of the first bridge and the plate; and
a second bracket configured to enclose and support an outer circumference of the second bridge.

2. The hydro roll rod of claim 1, wherein a nozzle is formed at a portion where the first liquid chamber and the second liquid chamber are partitioned to be extended from an end of the first bridge to an inside portion for of the first bridge in order to adjust a flow of the fluid.

3. The hydro roll rod of claim 2, wherein the nozzle is formed to be integrally extended from an end of the first bridge, and is spaced apart at a predetermined distance from an outer side surface of a bolt having a center at which an end of the nozzle is positioned.

4. The hydro roll rod of claim 3, wherein as the first liquid chamber or the second liquid chamber is compressed, the nozzle is curved in left and right directions to form a flow path through which fluid included in the first liquid chamber and the second liquid chamber moves.

5. The hydro roll rod of claim 1, wherein the first bridge, the rod case, the plate, and the first bracket are formed integrally by rubber vulcanization.
